(19) United States
(12) Patent Application Publication
(10) Pub. No.: US 2007/0099679 A1
(43) Pub. Date: May 3, 2007

(54) Wireless near field communication control using device state or orientation

(76) Inventor: Mikko Saarisalo, Kantvik (FI)

Correspondence Address: MORGAN & FINNEGAN, L.L.P., 3 World Financial Center, New York, NY, 10281-2101, US

(21) Appl. No.: 11/262,786

(22) Filed: Nov. 1, 2005

(51) Int. Cl. H04B 1/38

(52) U.S. Cl. 455/574

(57) ABSTRACT

A system for automatically controlling short-range wireless applications on a wireless communication device. The device includes a control table that may be accessed when the physical state or orientation of the wireless communication device changes. A change of physical state and/or orientation would include, for example, opening or closing a flip cover on the device. The control table includes information which may be used to determine when to enable/disable various short-range wireless applications, and may further include security and/or prioritization information for low-power situations. The user of the wireless communication device may be notified if certain security and/or power situations exist.

### BACKGROUND OF THE INVENTION

1. Field of Invention

The present invention relates to the controlling of functionality in a wireless communication device, and more specifically to activating or deactivating modes of short-range communication depending on the physical state or orientation of a wireless communication device.

2. Description of Prior Art

Modem society has quickly adopted, and become reliant upon, handheld devices for wireless communication. For example, cellular telephones continue to proliferate in the global marketplace due to technological improvements in both the quality of the communication and the functionality of the devices. These wireless communication devices (WCDs) have become commonplace for both personal and commercial use, allowing users to transmit and receive voice, text and graphical data from a multitude of geographical locations. The communication networks utilized by these devices span different frequencies and cover different broadcast distances, each having strengths desirable for various applications.

Cellular networks facilitate WCD communication over large geographic areas. These network technologies have commonly been divided by generations, starting in the late 1970s to early 1980s with first generation (1 G) analog cellular telephones that provided baseline voice communications, to the now emerging 4 G streaming digital video content planned for the 2006-2007 timeframe. GSM is an example of a widely employed 2 G digital cellular network communicating in the 900 MHZ-1.8 GHZ band in Europe and at 1.9 GHZ in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct broadcast to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth™ is an example of a short-range wireless technology quickly gaining acceptance in the marketplace. A Bluetooth™ enabled WCD transmits and receives data at a rate of 720 Kbps within a range of 10 meters, and may transmit up to 100 meters with additional power boosting. A user does not actively instigate a Bluetooth™ network. Instead, a plurality of devices within operating range of each other will automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master, and wait for an active slot to become available. These devices continually switch between various active communication and power saving modes in order to transmit data to other piconet members.

More recently, manufacturers have also began to incorporate various resources for providing enhanced functionality in WCDs (e.g., components and software for performing close-proximity wireless information exchanges). Sensors and/or scanners may be used to read visual or electronic information into a device. A transaction may involve a user holding their WCD in proximity to a target, aiming their WCD at an object (e.g., to take a picture) or sweeping the device over a printed tag or document. Machine-readable technologies such as radio frequency identification (RFID), Infra-red (IR) communication, optical character recognition (OCR) and various other types of visual, electronic and magnetic scanning are used to quickly input desired information into the WCD without the need for manual entry by a user.

Technological developments in wireless communication, such as those previously described, have created a desire in the public for the increased use of wireless communications in everyday applications. People want regular transactions to be quick, automated and error-free. For example, many public transit systems worldwide have moved to wireless smartcard systems to reduce the amount of currency handling on a per-trip basis. Systems such as SmarTrip, MIFARE, FeliCa, etc. use RFID communication to identify a rider as they pass through an entry gate or turnstile. In a normal scenario, the passenger presents a transponder card to a scanning device, which uses the identification information on the card to determine whether the particular rider's account contains a positive balance. If the rider has sufficient funds, the cost of the trip may be automatically deducted including a notification of the remaining balance. The problem with these systems are the many different individual RFID cards required for each service. Further, if a transponder card is lost or stolen, another individual may use the card to deduct or spend funds from the rightful owner's account until the owner realizes the card is missing and contacts the card provider.

The public transportation scenario is but one application for short-range wireless communication. Other standards using alterative communication methods exist for exchanging information in a number of different applications including identification information, credit card information, ticket information, credit or debit account transactions at a variety of locations from vending machines to full-service retailers, etc. There are also applications which exclusively deliver information to a user, such as advertisements including special offers and coupons, transportation schedules, event dates, etc. This array of available services multiplies the aforementioned problems, and creates new ones. Now the user is carrying many short-range communication devices, and risks the loss, theft and the potential unauthorized use of all of their personal information, accounts, etc.

The integration of wireless transponder cards into a single device would improve the user's ability to use and keep track of these services. However, the risk of loss or theft is now compounded because the previously described communication devices can be lost all at once (e.g., in the loss of the single WCD). Further, an actively polling application in a user device may wirelessly request or deliver information at any time, including an instance when the user is unaware. People with malicious intentions could abuse this functionality to steal information or create false credit or debit transactions. A secondary impact is the unintentional expenditure of power. A user may be unintentionally expending stored energy due to not disabling a polling mode when not in use.

In view of the above, what is needed is a system for automatically controlling resources in a wireless communication device depending on a physical state or orientation of the device, for example, depending on whether a movable element on a wireless communication device is open or closed. The behavior of the communication device should include settings for each wireless communication method and/or application, and should automatically decide when a security verification should be performed.

### SUMMARY OF INVENTION

The present invention consists of a method, apparatus and computer program for automatically controlling short-range wireless communications, including both hardware and software resources, depending on a physical state or orientation of a wireless communication device (WCD). The device may further control these communication resources with respect to power or security rules as defined by a user, and may notify the user if certain manual actions are required due to the current state or condition of the device.

In accordance with various embodiments of the present invention, the WCD may contain a table that is accessed whenever the physical state or orientation of the device is altered. The table may define, for each application and/or service, the permitted level of functionality for each state or orientation of the device. Further, a change from one state or orientation to another may require a security verification. A low power level may also cause certain actions to be performed, or may trigger a requirement for user intervention to re-establish an application.

The present invention may be employed with a multitude of applications and/or services, and helps to maintain security and power conservation in a wireless communication device with many simultaneously active applications. A user may specify the behavior of each of these services in a table so that certain more frequently used services can be prioritized over other applications.

### DESCRIPTION OF DRAWINGS

The invention will be further understood from the following detailed description of a preferred embodiment, taken in conjunction with appended drawings, in which:

FIG. 1 discloses an exemplary short-range to long-range wireless communication scenario in accordance with at least one embodiment of the present invention.

FIG. 2 discloses a modular description of an exemplary wireless communication device usable with at least one embodiment of the present invention.

FIG. 3A discloses a structural description of the exemplary wireless communication device previously described in FIG. 2.

FIG. 3B discloses examples of different movable elements creating various physical states or orientations in a wireless communication device usable in accordance with at least one embodiment of the present invention.

FIG. 4 discloses exemplary Near Field Communication (NFC) and active wireless information sources in accordance with at least one embodiment of the present invention.

FIG. 5 discloses an exemplary control table in accordance with at least one embodiment of the present invention.

FIG. 6 discloses an alternative exemplary control table in accordance with at least one embodiment of the present invention.

FIG. 7 discloses a flowchart describing a control process in accordance with at least one embodiment of the present invention.

FIG. 8A discloses an exemplary user interface for viewing a control table in accordance with at least one embodiment of the present invention.

FIG. 8B discloses an exemplary user interface for configuring a control table entry in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

I. Wireless Communication Over Different Communication Networks.

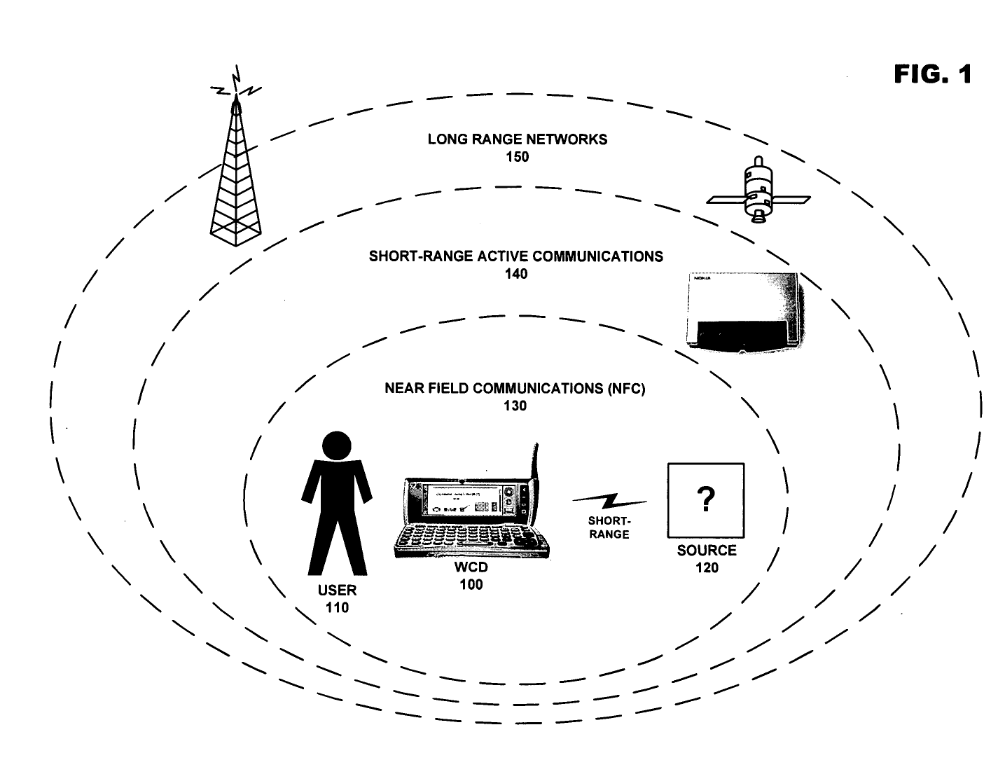

A WCD may both transmit and receive information over a wide array of wireless communication networks, each with different speed, range, quality (error correction), security (encoding), etc. characteristics. These characteristics will dictate the amount of information that may be transferred to a receiving device, and the duration of the information transfer. FIG. 1 includes a diagram of a WCD and how it interacts with various types of wireless networks.

In the example pictured in FIG. 1, user 110 possesses WCD 100. This device may be anything from a basic cellular handset to a more complex device such as a wirelessly enabled palmtop or laptop computer. Near Field Communications (NFC) 130 include various transponder-type interactions wherein normally only the scanning device requires its own power source. WCD 100 scans source 120 via short-range communication. A transponder in source 120 may use the energy and/or clock signal contained within the scanning signal, as in the case of RFID communication, to respond with data stored in the transponder. These types of technologies usually have an effective transmission range of a few inches to a few feet, and may be able to deliver stored data in amounts from 96 bits to over a megabit or 125 Kbytes relatively quickly. These characteristics make these technologies well suited for identification purposes, such as to receive an account number for a public transportation provider, a key code for an automatic door lock, an account number for a credit or debit transaction, etc.

The transmission range between two devices may be extended if both devices are capable of performing powered communications. Short-range active communications 140 includes devices wherein the sending and receiving devices are both active. An exemplary situation would include user 110 coming within effective transmission range of a Bluetooth™, WLAN, UWB, WUSB, etc. access point. In the case of Bluetooth™, a network may automatically be established to transmit information to WCD 100 possessed by user 110. This data may include information of an informative, educational or entertaining nature. The amount of information to be conveyed is unlimited, except that it must all be transferred in the time when user 110 is within effective transmission range of the access point. This duration is extremely limited if the user is, for example, strolling through a shopping mall or walking down a street. Due to the higher complexity of these networks, additional time is also required to establish the initial connection to WCD 100, which is extended if there are many devices queued for service in the transmission area. The transmission range of these networks depends on the technology, and may be from 32 ft. to over 300 ft. with additional power boosting.

Long-range networks 150 are used to give virtually uninterrupted coverage to WCD 100. Land-based repeaters or satellites are used to deliver communication coverage worldwide. While these systems are extremely functional, the use of these systems are often charged on a per-minute basis to user 110, with additional charges for data transfer, like wireless Internet access. Further, the regulations covering these systems cause additional overhead for both the users and providers, making the use of these systems more cumbersome.

II. Wireless Communication Device

As previously described, the present invention may be utilized with a variety of wireless communication equipment. Therefore, it is also important to understand the communication tools available to user 110 before exploring the present invention. For example, in the case of a cellular telephone or other handheld wireless device, the integrated data handling capabilities play an important role in facilitating the transaction between the transmitting and receiving devices.

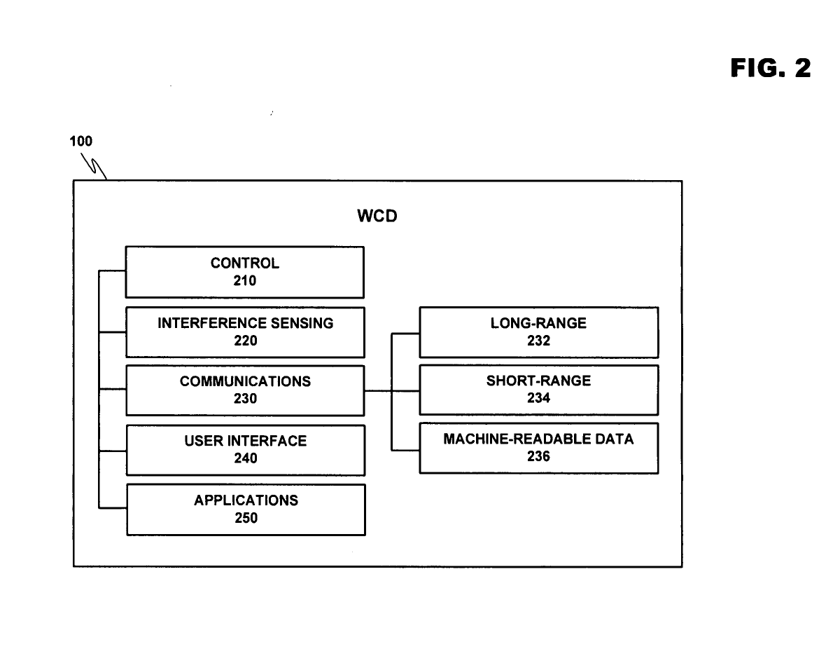

FIG. 2 discloses an exemplary modular layout for a wireless communication device usable with the present invention. WCD I 00 is broken down into modules representing the functional aspects of the device. These functions may be performed by the various combinations of software and/or hardware components discussed below.

Control module 210 regulates the operation of the device. Inputs may be received from various other modules included within WCD 100. For example, interference sensing module 220 may use various techniques known in the art to sense sources of environmental interference within the effective transmission range of the wireless communication device. Control module 210 interprets these data inputs and in response may issue control commands to the other modules in WCD 100.

Communications module 230 incorporates all of the communications aspects of WCD 100. As shown in FIG. 2, communications module 230 includes, for example, long-range communications module 232, short-range communications module 234 and machine-readable data module 236. Communications module 230 utilizes at least these sub-modules to receive a multitude of different types of communication from both local and long distance sources, and to transmit data to recipient devices within the broadcast range of WCD 100. Communications module 230 may be triggered by control module 210 or by control resources local to the module responding to sensed messages, environmental influences and/or other devices in proximity to WCD 100.

User interface module 240 includes visual, audible and tactile elements which allow the user 110 to receive data from, and enter data into, the device. The data entered by user 110 may be interpreted by control module 210 to affect the behavior of WCD 100. User-inputted data may also be transmitted by communications module 230 to other devices within effective transmission range. Other devices in transmission range may also send information to WCD 100 via communications module 230, and control module 210 may cause this information to be transferred to user interface module 240 for presentment to the user.

Applications module 250 incorporates all other hardware and/or software applications on WCD 100. These applications may include sensors, interfaces, utilities, interpreters, data applications, etc., and may be invoked by control module 210 to read information provided by the various modules and in turn supply information to requesting modules in WCD 100.

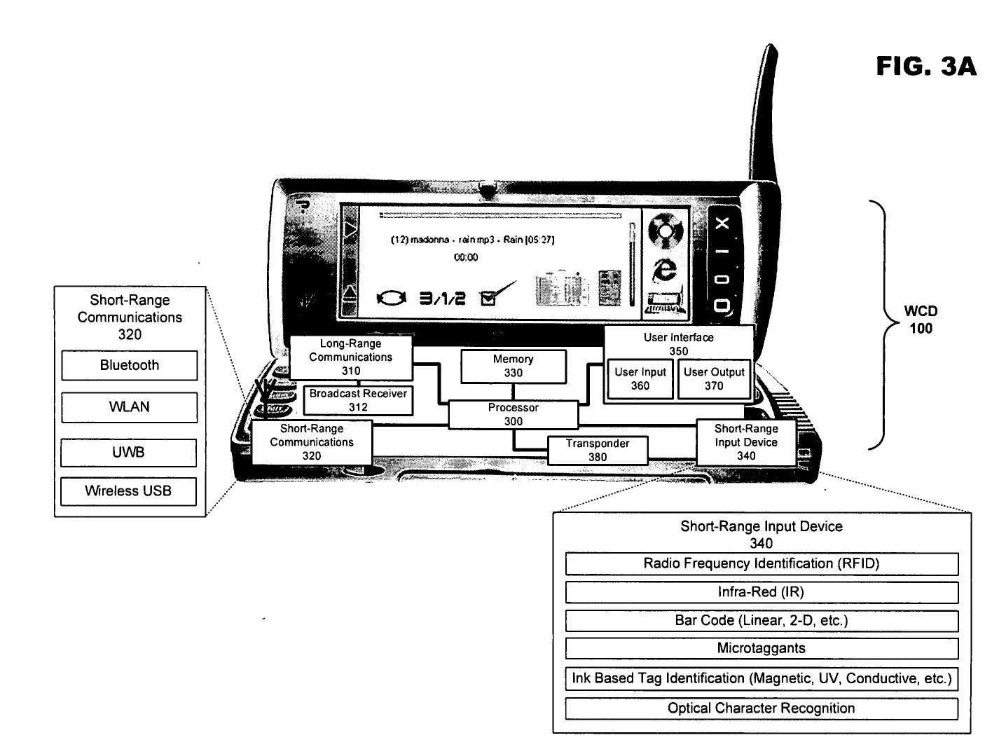

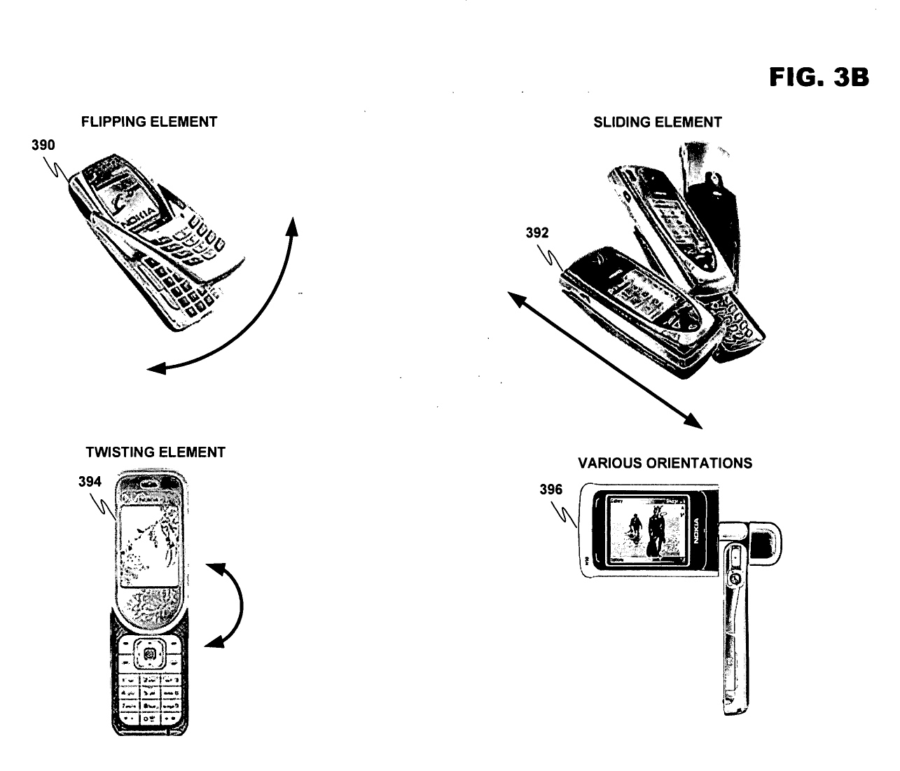

FIG. 3A discloses an exemplary structural layout of WCD 100 according to an embodiment of the present invention that may be used to implement the functionality of the modular system previously described. Processor 300 controls overall device operation. As shown in FIG. 3A, processor 300 is coupled to communications sections 310, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

The software components stored by memory 330 include instructions that can be executed by processor 300. Various types of software components may be stored in memory 330. For instance, memory 330 may store software components that control the operation of communication sections 310, 320 and 340. Memory 330 may also store software components including a firewall, a service guide manager, a bookmark database, user interface manager, and any communications utilities modules required to support WCD 100.

Long-range communications 310 performs functions related to the exchange of information over large geographic areas (such as cellular networks) via an antenna. These communication methods include technologies from the previously described 1 G to 3 G and soon fourth generation streaming video transmission. In addition to basic voice communications (e.g., via GSM), long-range communications 310 may operate to establish data communications sessions, such as General Packet Radio Service (GPRS) sessions and/or Universal Mobile Telecommunications System (UMTS) sessions. Also, long-range communications 310 may operate to transmit and receive messages, such as short messaging service (SMS) messages and/or multimedia messaging service (MMS) messages.

As a subset of long-range communications 310, or alternatively operating as an independent module separately connected to processor 300 (not pictured), broadcast receiver 312 allows WCD 100 to receive broadcast messages via mediums such as Digital Video Broadcast for Handheld Devices (DVB-H). These transmissions may be encoded so that only certain designated receiving devices may access the broadcast content, and may contain text, audio or video information. In at least one example, WCD 100 may receive these broadcasts and use information contained within the broadcast signal to determine if the device is permitted to view the received content.

Short-range communications 320 is responsible for functions involving the exchange of information across short-range wireless networks. As described above and depicted in FIG. 3A, examples of such short-range communications 320 are not limited to Bluetooth™, WLAN, UWB and Wireless USB connections. Accordingly, short-range communications 320 performs functions related to the establishment of short-range connections, as well as processing related to the transmission and reception of information via such connections.

Short-range input device 340, also depicted in FIG. 3A, may provide functionality related to the short-range scanning of machine-readable data. For example, processor 300 may control short-range input device 340 to generate RF signals for activating an RFID transponder, and may in turn control the reception of signals from an RFID transponder. Other short-range scanning methods for reading machine-readable data that may be supported by the short-range input device 340 are not limited to IR communications, linear and 2-D (e.g., QR) bar code readers (including processes related to interpreting UPC labels), and optical character recognition devices for reading magnetic, UV, conductive or other types of coded data that may be provided in a tag using suitable ink. In order for the short-range input device 340 to scan the aforementioned types of machine-readable data, the input device may include optical detectors, magnetic detectors, CCDs or other sensors known in the art for interpreting machine-readable information.

As further shown in FIG. 3A, user interface 350 is also coupled to processor 300. User interface 350 facilitates the exchange of information with a user. FIG. 3A shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 100 may also include one or more transponders 380. This is essentially a passive device which may be programmed by processor 300 with information to be delivered in response to a scan from an outside source. For example, an RFID scanner mounted in a entryway may continuously emit radio frequency waves. When a person with a device containing transponder 380 walks through the door, the transponder is energized and may respond with information identifying the device, the person, etc.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communications components stored in memory 330.

The elements shown in FIG. 3A may be constituted and coupled according to various techniques in order to produce the functionality described in FIG. 2. One such technique involves coupling separate hardware components corresponding to processor 300, communications sections 310, 312 and 320, memory 330, short-range input device 340, user interface 350, transponder 380, etc. through one or more bus interfaces. Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communications utilities software component, also contained in memory 330, which provides for the establishment of service sessions using long-range communications 310 and/or short-range communications 320. The communications utilities component may include various routines that allow the reception of services from remote devices according to mediums such as the Wireless Application Medium (WAP), Hypertext Markup Language (HTML) variants like Compact HTML (CHTML), etc.

When engaging in WAP communications with a remote server, the device functions as a WAP client. To provide this functionality, the software components may include WAP client software components, such as a Wireless Markup Language (WML) Browser, a WMLScript engine, a Push Subsystem, and a Wireless Medium Stack.

Applications (not shown) may interact with the WAP client software to provide a variety of communications services. Examples of such communications services include the reception of Internet-based content, such as headline news, exchange rates, sports results, stock quotes, weather forecasts, multilingual phrase dictionaries, shopping and dining information, local transit (e.g., bus, train, and/or subway) schedules, personal online calendars, and online travel and banking services.

The WAP-enabled device may access small files called decks which each include smaller pages called cards. Cards are small enough to fit into a small display area that is referred to herein as a microbrowser. The small size of the microbrowser and the small file sizes are suitable for accommodating low memory devices and low-bandwidth communications constraints imposed by wireless links.

Cards are written in the Wireless Markup Language (WML), which is specifically devised for small screens and one-hand navigation without a keyboard. WML is scaleable so that it is compatible with a wide range of displays that covers two-line text displays, as well as large LCD screens found on devices, such as smart phones, PDAs, and personal communicators. WML cards may include programs written in WMLScript, which is similar to JavaScript. However, through the elimination of several unnecessary functions found in these other scripting languages, WMLScript reduces memory and processing demands.

CHTML is a subset of the standard HTML command set adapted for use with small computing devices (e.g., mobile communicator, PDA, etc.). This language allows portable or handheld devices interact more freely on the Internet. CHTML takes into consideration the power, processing, memory and display limitations of small computing devices by stripping down standard HTML to a streamlined version suitable for these constraints. For example, many of the more advanced image maps, backgrounds, fonts, frames, and support for JPEG images have been eliminated. Further, scrolling is not supported because it is assumed that CHTML displays will fit within the screen of a portable device. CHTML has also been designed to operated without two dimensional cursor movement. Instead, it may be manipulated with only four buttons, which facilitates its implementation over a larger category of small computing devices.

FIG. 3B discloses exemplary physical states or orientations of various wireless communication devices. WCD 390 has a hinged element that opens to present additional device features to a user. WCD 390 may commonly be considered a “flip-phone” style wireless communication device. WCD 392 has a sliding element instead of a hinged element like a flip phone. The sliding element slides to expand the usable surface of the device and expose additional hidden controls. WCD 394 also includes a movable element to increase the usable surface of the device, but moves with a twisting or scissor-like motion to open. It is also possible that a device may incorporate multiple moving elements, as in the case of WCD 396. Here the device opens like a flip-phone, but also incorporates a rotating element to expose the display of WCD 396 to the user when the device is closed. These devices may include various inputs and/or sensors to determine when the physical state or orientation of the WCD has changed, as well as the current state or orientation of the device.

III. Short-Range Device Interaction

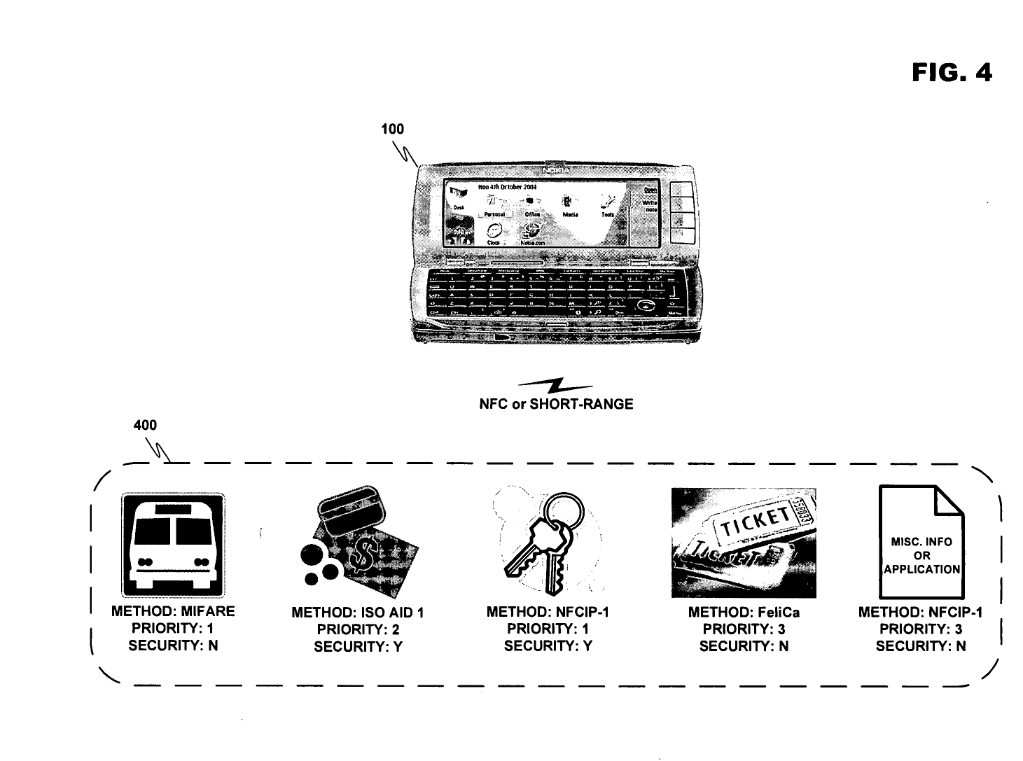

The various embodiments of the present invention presented herein are an improvement over the prior art because they incorporate various short-range communication methods and applications into a single device. FIG. 4 is an exemplary situation wherein WCD 100 may support a variety of different short-range applications and/or services that would otherwise be handled by different individual devices. These applications include, but are not limited to a public transportation debit account, a cash credit or debit account, an entry access security application, an event ticketing application and miscellaneous other data handling applications. These applications may be performed using a variety of short-range wireless communication methods as previously described.

Each application and/or service in FIG. 4 may have characteristic information that determines control behavior for WCD 100. For example, the public transportation application has characteristics that determine it communicates using a MIFARE wireless transaction service, it is has a priority of 1 (highest) as set by the user, and that a security check is not needed when the physical state or orientation of WCD 100 changes. The priority indicates that the user desires WCD 100 to keep the application active even if the power in the device becomes depleted. WCD 100 may end lower priority applications before a priority 1 application, or alternatively, may encode information related to this application and/or service in transponder 380 which does not require power from WCD 100 in order to operate. This device may receive power from an exterior scanning device when presented. In this case, user 110 wants to avoid being stranded without access to transportation, despite the low power status of WCD 100. A security check is not needed both because the risk to the user is minimal if the device is lost (not much money in the account) as compared to the frequency of use (it would be cumbersome for user 110 to have to enter a security code every time the device is opened or closed).

This may be contrasted to a cash credit or debit account application using the ISO AID 1 communication service, wherein the user will always want a security check prior to enabling the application when a change of physical state or orientation of WCD 100 is detected. The security check is desired because this application may grant direct access to the financial accounts of user 110. The cash credit or debit account has a priority of 2. This means in the event of a low power situation, WCD 100 may disable this feature to save power before disabling a priority 1 application. WCD 100 may prompt a user to override this shutdown in order to perform a purchase transaction. User 110 may be notified of an application shutdown via visual or audio notification, and through a keypress, entering a code, etc., may be able to reinitiate an application.

The access or key application communicates via the NFCIP-1 communication service and has priority level of 1 with security enabled. This feature may unlock doors to grant access to a building, and so user 110 may desire it to be active regardless of the power condition of the device. However, this option may be protected by only being enabled when the device is open, and since the security option is enabled, a password or depressing a specific key on the device may be required to activate or alter it. This prevents another person who obtains the device from gaining access to a secured premises. The information for this application may be written to the transponder of WCD 100 (e.g., the previous MIFARE information may be overwritten when the device is opened) or it may be written to another transponder in the device.

Further ticketing and miscellaneous data application examples are also shown in FIG. 4. These applications have a priority of 3 (low priority) and no security requirements. These applications may be immediately shut down if there is a low power condition without any notification to the user. The user may reactivate these application manually if they are required.

IV. Control Tables

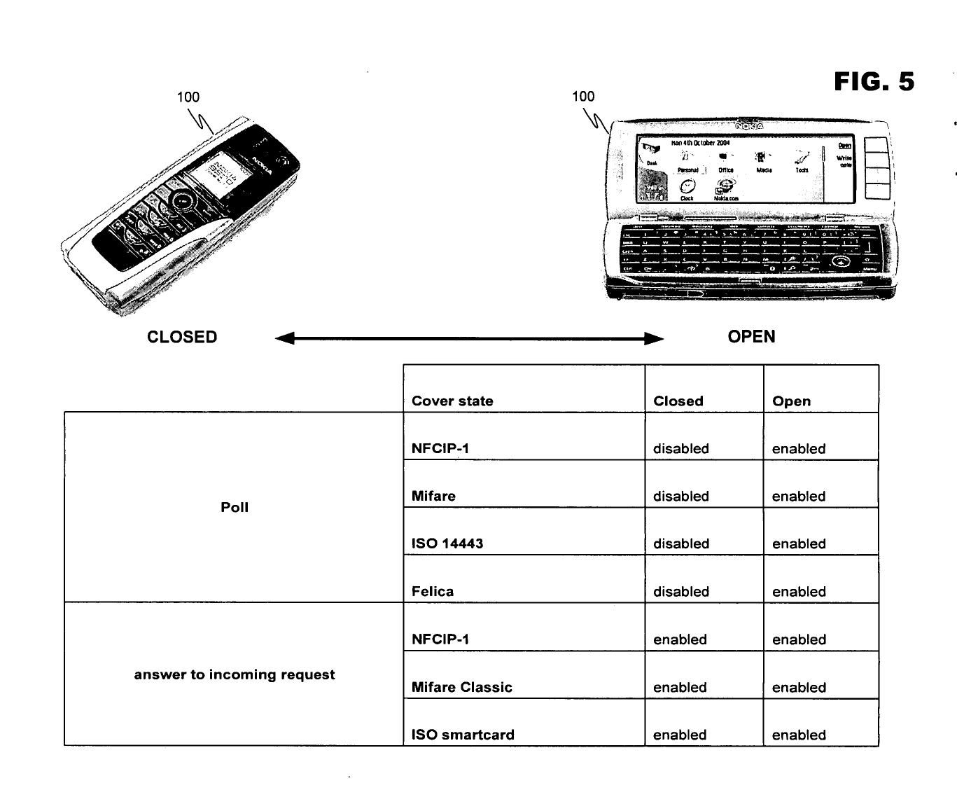

FIG. 5 discloses a basic control table usable with at least one embodiment of the present invention. The physical state or orientation of WCD 100 is tracked in at least two states: “CLOSED” and “OPEN.” Other sensors may be employed such as light/dark sensors, tilt sensors, etc. to sense other physical aspects of WCD 100. This may vary depending on the type of device (e.g., flip-phone style, slide-open style, etc. as described in FIG. 3B). The control table in FIG. 5 discloses various services for short-range wireless communication, and whether these services are “enabled” or “disabled” when WCD 100 is closed or open.

In the disclosed example, the active or “polling” modes and the passive or “answer” modes are classified separately for each wireless service. This provides both a power conservation and security benefit for WCD 100. For example, the device is usually closed when not in use. Therefore, all polling modes functions are disabled. This saves the power that would be needed by WCD 100 to actively poll for other devices, and prevents inadvertent connections and the transfer of information to other devices unknown to user 110. On the other hand, some basic answer mode functionality is enabled when the phone is closed. This allows user 110 to wirelessly deliver information, such as to a scanner for the MIFARE service, without having to open WCD 100. Since this service is used most frequently to pay for public transportation, the amount of use, which is high, outweighs the power burden and security risk, which is low.

When WCD 100 is opened, the device becomes totally enabled. This is shown in FIG. 5, wherein the polling and answer modes of all the protocols are fully activated. The presumption is that user 110 is now using the device, and is fully aware of all active communication transactions. However, the situation may arise wherein another person besides user 10 has obtained possession of the device, and is trying to access features to gain information about user 110 or to misappropriate the user's accounts. The security and/or priority features, disclosed in FIG. 4 and discussed further below, may serve to prevent this situation.

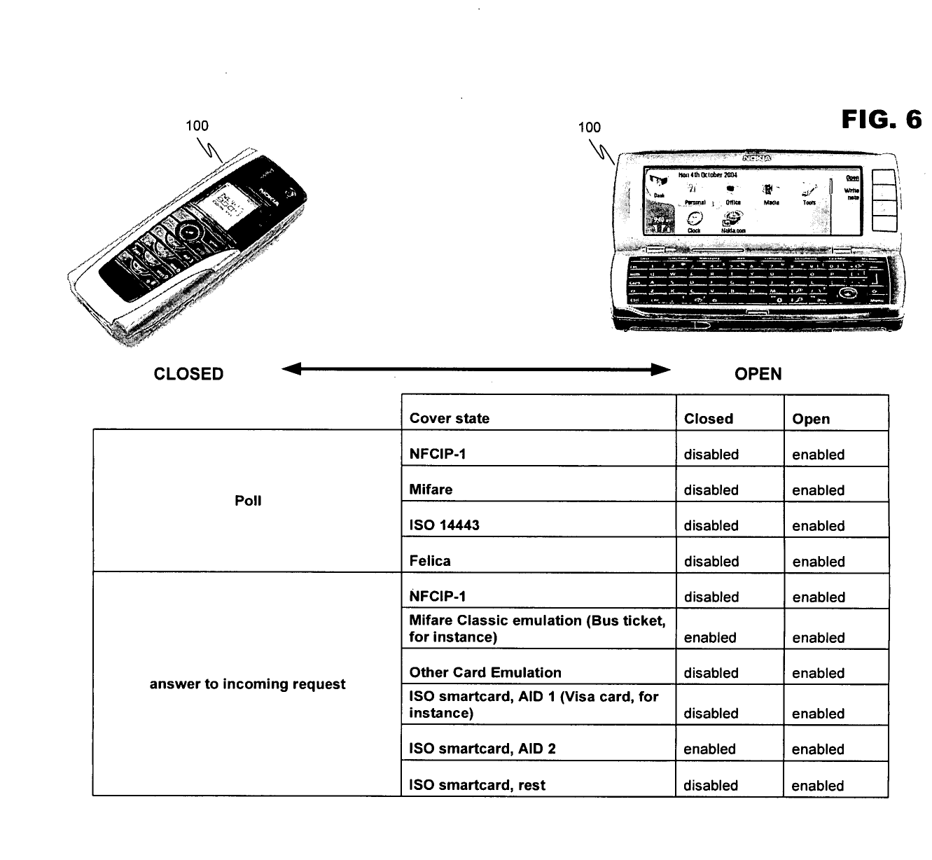

FIG. 6 discloses another more detailed embodiment of the control table usable with at least one embodiment the present invention. In this example, similar communications services are controlled using the physical state or orientation of WCD 100, but the specificity of control has been increased. In this example, when the device is closed, the ISO smartcard AID 2 application is enabled since there is little security risk. However, the ISO smartcard AID 1 application, which may provide credit account information like a Visa card information, is disabled. This prevents someone with malicious intent from appropriating account information when user 110 is not using the device. This application is later enabled when the device is opened. To further protect this application, user 10 may indicate a requirement for an access or security code after WCD 100 is opened before enabling this application. This additional security measure ensures that another person who obtains the device will not be able to access this information simply by opening the device. This security verification may be set on an application by application basis. Alternatively, a general code may be required whenever the device is opened. If the device is closed again without the entry of the code, all wireless functions may be ceased, effectively putting the device in a “lock down” mode until the correct code is entered.

Further, the open or closed state of WCD 100 may determine how different priority applications are enabled when power in the device is depleted. A high priority (1) application may be active regardless of a low power condition. A priority 2 application may be inactive when the device is closed, but may become active when the device is opened. A priority 3 application may be disabled when the device is closed, and then may require user intervention to activate it after WCD 100 is opened. While definitive examples of functional settings have been given, any combination of activation, security and priority level for power conservation may be established, depending on the particular requirements of user 110. Settings may further be used to determine a polling rate in searching for other devices, the types of other devices to be polled, the types of other devices to which to respond, the strength of polling signal to which to respond, the permitted duration of connection, etc.

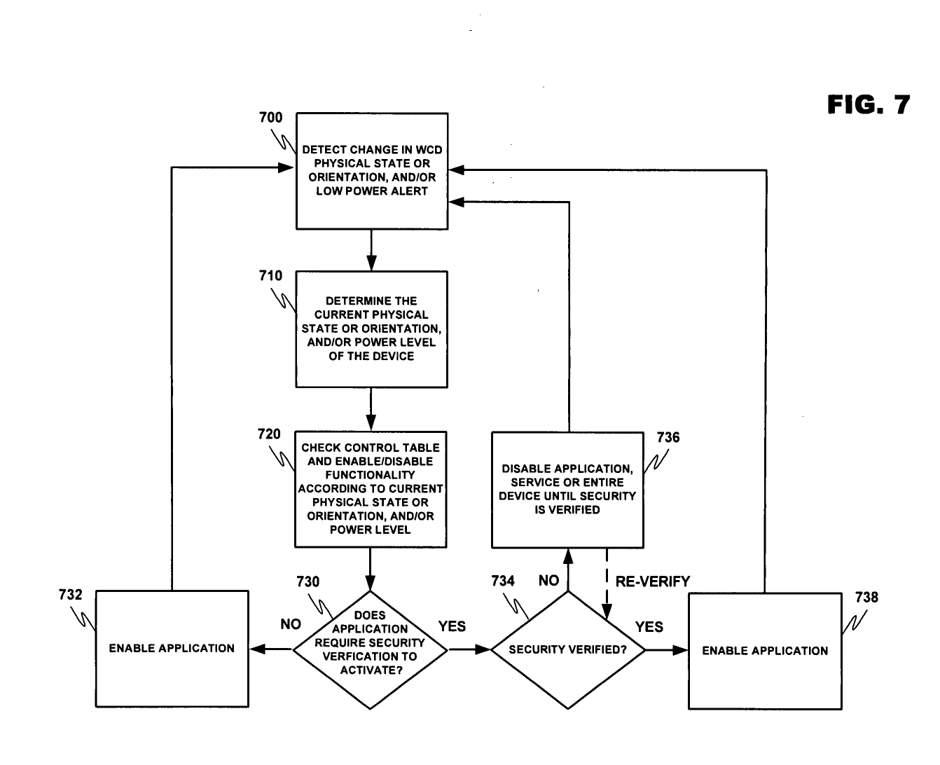

FIG. 7 discloses an'exemplary flow chart in accordance with at least one embodiment of the present invention. In step 700, a change in physical state or orientation, and/or a depleted power level is detected in WCD 100. The change of state, orientation and/or power level may be detected by a variety of inputs and/or sensors in the device. After the condition of WCD 100 is determined, one or more control tables may be accessed to determine if and how to alter the functionality of the device in terms of these characteristics (steps 710 and 720). The device may, as a result of the sensed conditions, activate or deactivate various hardware resources (e.g., resources associated with active scanning) and/or software applications associated with various services configured by user 110. If the state or orientation characteristics dictate enabling applications, the control table may also require WCD 100 to check for user specified security requirements in step 730. If no security verification is required, the device activates the application in step 732 and may continue with normal operation until another change of physical state, orientation and/or power level is detected. Alternatively, if a security verification is required, WCD 100 will attempt to verify security before enabling the application (or entire device) in steps 734 and 736. After the user is verified, WCD 100 may activate the application (step 738) and may continue with normal operation until another change of physical state, orientation and/or power level is detected.

V. User Interface

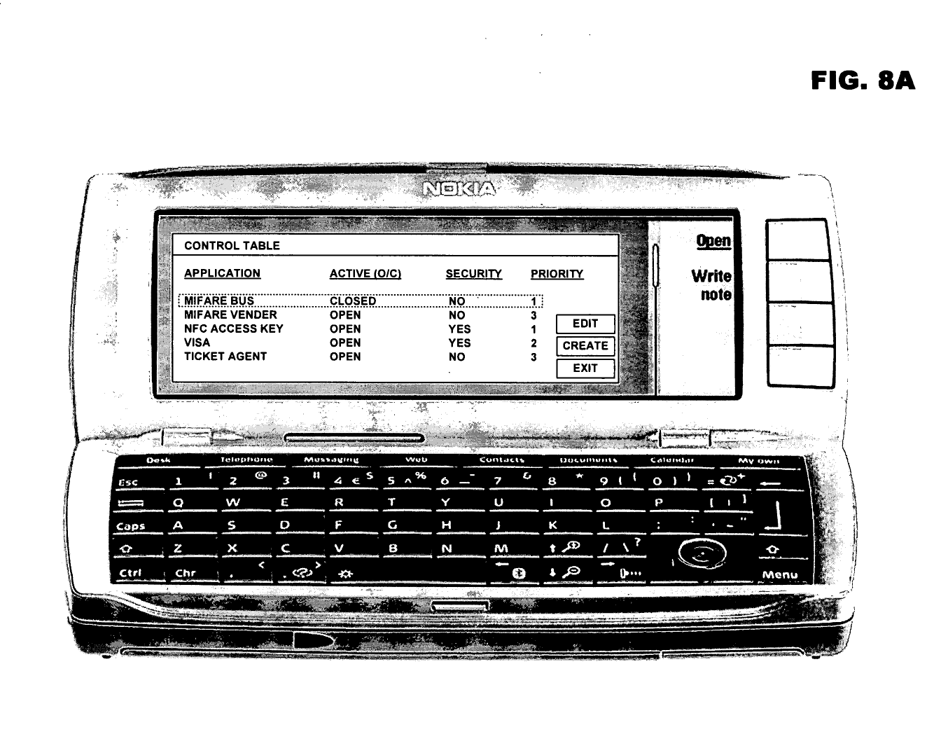

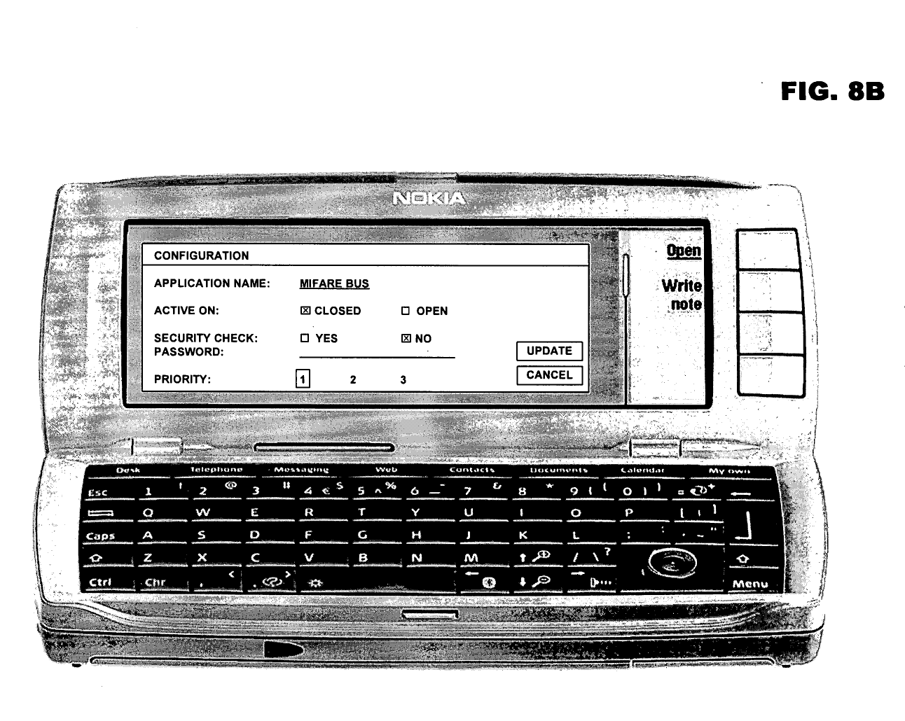

FIG. 8A and 8B depict exemplary user interfaces usable in accordance with at least one embodiment of the present invention. FIG. 8A shows an example of a control table. The appearance or contents of the control table may vary depending on the abilities of WCD 100. In this example, the control table includes an application name, when the application is active, when security is required, and the priority level of the application. The first two entries in the table are for the MIFARE service. The MIFARE bus service is active when the device is closed, allowing User 110 to use WCD 100 to electronically pay fares for public transportation. When the device is opened, MIFARE vender becomes active so that the user may purchase food, drinks, photocopies, etc. from various electronic vending machines also equipped to user the MIFARE service. In this way, the same service may be enabled in two completely different modes depending on the physical state or orientation of the device. Other examples of different services are also listed with their applicable operating characteristics.

When user 110 wants to edit an existing table entry, or add a new table entry, they may invoke a configuration interface such as the one disclosed in FIG. 8B. The configuration screen includes options for user 110 to set all of the control characteristics shown in the control table of FIG. 8A. The configuration options may include various selectors such as check boxes, pull down menus, text entry fields, etc. depending on the capabilities of WCD 100. User 110 may then choose to save their changes by selecting to “update” the control table with the information entered in FIG. 8B.

The present invention is an improvement over the prior art in that it allows a user to consolidate many individual wireless communication devices used in everyday commerce into a single wireless communication device without concerns related to any consequences from loss, theft or power depletion in the device. The present invention adds ingenuous intelligence to the wireless communication device, customizing the behavior of the device to account for user preferences according to the physical state or orientation of the device, the user's concerns regarding the security of applications and information on the device, and the criticality of various functions of the device when the power becomes low. These preferences are compiled in tables used to automatically control the behavior of the device, allowing the user to employ the wireless communication device more frequently for common transactions that are simple, secure and efficient.

Accordingly, it will be apparent to persons skilled in the relevant art that various changes in forma and detail can be made therein without departing from the spirit and scope of the invention. The breadth and scope of the present invention should not be limited by any of the above-described exemplary embodiments, but should be defined only in accordance with the following claims and their equivalents.

1. A method for controlling a wireless communication device, comprising:
detecting a change in the physical state or orientation of a wireless communication device;
accessing a memory containing information related to the operation of short-range wireless applications and/or services in the wireless communication device; and
controlling the wireless communication device to enable or disable the short-range wireless applications and/or services depending on the detected physical state or orientation of the wireless communication device.

2. The method of claim 1, wherein the wireless communication device includes at least one movable element; and
detecting a change in the physical state or orientation of the wireless communication device includes sensing a change in position of the movable element.

3. The method of claim 2, wherein the movable element includes a flipping element, a sliding element, a twisting element, or combinations thereof.

4. The method of claim 1, wherein the information related to the operation of short-range wireless applications and/or services in the wireless communication device includes a control table.

5. The method of claim 4, wherein the control table contains information including conditions that determine whether to enable or disable each short-range wireless application and/or service based on the physical state or orientation of the wireless communication device.

6. The method of claim 5, wherein enabling includes placing the short-range wireless application and/or service in an active polling mode; and
disabling includes placing the short-range wireless application and/or service in a passive receiving mode.

7. The method of claim 5, wherein enabling includes placing the short-range wireless application and/or service in a passive receiving mode; and
disabling includes deactivating the short-range wireless application and/or service.

8. The method of claim 4, wherein the control table contains information including when a security verification is required to enable a short-range wireless application and/or service.

9. The method of claim 4, wherein the control table contains information including a priority level for each short-range wireless application and/or service in regard to a low power situation.

10. The method of claim 1, further comprising controlling short-range wireless hardware resources depending on the detected physical state or orientation of the wireless communication device.

11. The method of claim 10, wherein short-range wireless hardware resources include transmitters and/or transponders in the wireless communication device.

12. The method of claim 11, wherein the transmitters and/or transponders communicate via RFID communication.

13. The method of claim 11, wherein the transmitters and/or transponders are activated, deactivated or rewritten depending on the detected physical state or orientation of the wireless communication device.

14. The method of claim 1, further comprising a notification to a user when a security verification is required and/or if a low power situation exists.

15. A wireless communication device, comprising:
sensors for detecting a change in the physical state or orientation of a wireless communication device;
a memory containing information related to the operation of short-range wireless applications and/or services in the wireless communication device; and
a computing device for controlling the wireless communication device to enable or disable the short-range wireless applications and/or services depending on the detected physical state or orientation of the wireless communication device.

16. The wireless communication device of claim 15, further comprising at least one movable element; and
detecting a change in the physical state or orientation of the wireless communication device includes sensing a change in position of the movable element.

17. The wireless communication device of claim 16, wherein the movable element includes a flipping element, a sliding element, a twisting element, or combinations thereof.

18. The wireless communication device of claim 15, wherein the information related to the operation of short-range wireless applications and/or services in the wireless communication device includes a control table.

19. The wireless communication device of claim 18, wherein the control table contains information including conditions that determine whether to enable or disable each short-range wireless application and/or service based on the physical state or orientation of the wireless communication device.

20. The wireless communication device of claim 19, wherein enabling includes placing the short-range wireless application and/or service in an active polling mode; and
disabling includes placing the short-range wireless application and/or service in a passive receiving mode.

21. The wireless communication device of claim 19, wherein enabling includes placing the short-range wireless application and/or service in a passive receiving mode; and
disabling includes deactivating the short-range wireless application and/or service.

22. The wireless communication device of claim 18, wherein the control table contains information including when a security verification is required to enable a short-range wireless application and/or service.

23. The wireless communication device of claim 18, wherein the control table contains information including a priority level for each short-range wireless application and/or service in regard to a low power situation.

24. The wireless communication device of claim 15, further comprising controlling short-range wireless hardware resources depending on the detected physical state or orientation of the wireless communication device.

25. The wireless communication device of claim 24, wherein short-range wireless hardware resources include transmitters and/or transponders in the wireless communication device.

26. The wireless communication device of claim 25, wherein the transmitters and/or transponders communicate via RFID communication.

27. The wireless communication device of claim 25, wherein the transmitters and/or transponders are activated, deactivated or rewritten depending on the detected physical state or orientation of the wireless communication device.

28. The wireless communication device of claim 15, further comprising a notification to a user when a security verification is required and/or if a low power situation exists.

29. A computer program product comprising a computer usable medium having computer readable program code embodied in said medium for controlling a wireless communication device, comprising:
a computer readable program code for detecting a change in the physical state or orientation of a wireless communication device;
a computer readable program code for accessing a memory containing information related to the operation of short-range wireless applications and/or services in the wireless communication device; and
a computer readable program code for controlling the wireless communication device to enable or disable the short-range wireless applications and/or services depending on the detected physical state or orientation of the wireless communication device.

30. The computer program product of claim 29, wherein the wireless communication device includes at least one movable element; and
detecting a change in the physical state or orientation of the wireless communication device includes sensing a change in position of the movable element.

31. The computer program product of claim 30, wherein the movable element includes a flipping element, a sliding element, a twisting element, or combinations thereof.

32. The computer program product of claim 29, wherein the information related to the operation of short-range wireless applications and/or services in the wireless communication device includes a control table.

33. The computer program product of claim 32, wherein the control table contains information including conditions that determine whether to enable or disable each short-range wireless application and/or service based on the physical state or orientation of the wireless communication device.

34. The computer program product of claim 33, wherein enabling includes placing the short-range wireless application and/or service in an active polling mode; and
disabling includes placing the short-range wireless application and/or service in a passive receiving mode.

35. The computer program product of claim 33, wherein enabling includes placing the short-range wireless application and/or service in a passive receiving mode; and
disabling includes deactivating the short-range wireless application and/or service.

36. The computer program product of claim 32, wherein the control table contains information including when a security verification is required to enable a short-range wireless application and/or service.

37. The computer program product of claim 32, wherein the control table contains information including a priority level for each short-range wireless application and/or service in regard to a low power situation.

38. The computer program product of claim 29, further comprising controlling short-range wireless hardware resources depending on the detected physical state or orientation of the wireless communication device.

39. The computer program product of claim 38, wherein short-range wireless hardware resources include transmitters and/or transponders in the wireless communication device.

40. The computer program product of claim 39, wherein the transmitters and/or transponders communicate via RFID communication.

41. The computer program product of claim 39, wherein the transmitters and/or transponders are activated, deactivated or rewritten depending on the detected physical state or orientation of the wireless communication device.

42. The computer program product of claim 29, further comprising a notification to a user when a security verification is required and/or if a low power situation exists.

43. A method for controlling a wireless communication device, comprising:
detecting a change in the physical state or orientation of a wireless communication device;
accessing a memory containing information including a control table; and
controlling resources related to RFID communication in the wireless communication device using information pertaining to the detected physical state or orientation of the wireless communication device included in the control table.

44. A wireless communication device, comprising:
sensors for detecting a change in the physical state or orientation of a wireless communication device;
a memory containing information including a control table; and
a computing device for controlling resources related to RFID communication in the wireless communication device using information pertaining to the detected physical state or orientation of the wireless communication device included in the control table.

45. A computer program product comprising a computer usable medium having computer readable program code embodied in said medium for controlling a wireless communication device, comprising:
a computer readable program code for detecting a change in the physical state or orientation of a wireless communication device;
a computer readable program code for accessing a memory containing information including a control table; and
a computer readable program code for controlling resources related to RFID communication in the wireless communication device using information pertaining to the detected physical state or orientation of the wireless communication device included in the control table.
